(19) United States
(12) Patent Application Publication
(10) Pub. No.: US 2008/0190858 A1
(43) Pub. Date: Aug. 14, 2008

(54) Flotation Process And Apparatus For Separating Suspended Particles From A Liquid

(76) Inventor: Berrie Christopher Woodbridge, Ludlow (GB)

Correspondence Address: LATHROP & GAGE LC, 2345 GRAND AVENUE, SUITE 2800, KANSAS CITY, MO, 64108, US

(21) Appl. No.: 11/572,377

(22) PCT Filed: Jul. 14, 2005
(86) PCT No.: PCT/GB05/02767

§ 371 Date: Jan. 19, 2007

(30) Foreign Application Priority Data
Jul. 20, 2004 (GB) 0416147.7

(51) Int. Cl. C02F 1/52; B03D 1/14

(52) U.S. Cl. 210/705; 210/221.2

(57) ABSTRACT

A process and apparatus for separating suspended solid material from a fluid, comprising the steps of adding in a chamber buoyant media as glass spheres with 30-250 micron diameter (106) to the fluid to form a first mixture of fluid influent and buoyant media, adding a flocculant (108) to the said first mixture to form a second mixture of influent, buoyant media and flocculant, transferring said second mixture to a flotation chamber (200), introducing a pressurised fluid (203) to the second mixture in said flotation chamber, removing separated floating sludge from said flotation chamber, and removing separated clarified effluent from said flotation chamber Optionally, a coagulant may be added after the flocculant.

The invention relates to the separation of suspended particles from liquid and is particularly, though not exclusively, applicable to the separation of solid waste from a mixture of sewage and rain water (hereinafter “waste water”). The invention may also be used to separate particles from potable water supplies. The invention utilises buoyant media and a flocculant in the separation process.

It is known to use buoyant media in such separation processes for example in Patent Co-Operation Treaty Application WO 0160494 (Penno et al) there is described a process and system in which the influent waste water is mixed with a coagulant and/or flocculant to form a mixed fluid to which is added buoyant media and directing this resultant mixed fluid to a flotation chamber where the suspended solid portion of the influent is floated off leaving clarified waste water. A pressurised liquid and gas is optionally added to assist separation, the gas generally being air. The latter use of a gas (air) is known as Dissolved Air Flotation (DAF).

It has been found that the above known system has a drawback in that the throughput is not very large or efficient, probably due to the light ballast (buoyant media) not binding with the suspended solid particles.

The present invention provides a process for separating suspended solid material from a fluid, comprising the steps of:
a) adding buoyant media to the fluid to form a first mixture of fluid influent and buoyant media,
b) adding a flocculant to the said first mixture to form a second mixture of influent, buoyant media, and flocculant,
c) transferring said second mixture to a flotation chamber,
d) introducing a pressurised fluid to the said second mixture in said flotation chamber,
e) removing separated floating sludge from said flotation chamber, and
f) removing separated clarified effluent from said flotation chamber.

Preferably, there is an additional step after step a) and before b) in which a coagulant is added to the said first mixture to form a buoyant coagulated mixture before the addition of flocculent in step b).

The pressurised fluid is preferably a pressurised liquid including dissolved gas, desirably air.

Advantageously, the pressurised fluid is a portion of the clarified effluent mixed with the gas before said fluid is introduced into said flotation chamber.

In a preferred process the gas is supplied dissolved in a portion of the final effluent from the process which is re-cycled, pressurised and the gas is dissolved within said pressurised final effluent portion.

The said portion is preferably pressurised typically to about 5 bar and the gas is air at about 6 bar dissolved in said portion.

The buoyant media preferably has a bulk density of 50-500 kg per cubic metre.

The buoyant media preferably comprises particles of diameter in the range of 30-250 micron. The buoyant media is preferably provided by (generally spherical) glass particles.

The additional step is particularly applicable to the treatment of potable water.

The invention also provides in another aspect, apparatus for the separation of suspended solid material from a fluid comprising a first chamber for the flocculation of the suspended material and a second chamber for flotation of flocculated floating sludge from clarified fluid, means for transferring material from the said chamber to the second chamber, the first chamber having a first inlet for (untreated) influent, a second inlet for the introduction of buoyant media for entrainment and mixing of said buoyant media with said influent to form a first mixture, and a third inlet for flocculent material for entrainment and mixing of said flocculent with said already-mixed first mixture to form a second mixture, before said second mixture is transferred to said second chamber.

The first chamber may be divided into two interconnecting regions, a first region where said first and second inlets are disposed and a second region connected to said first region and having said third inlet and also having said means for transferring said second mixture from said second region to said second chamber. Preferably said means for transferring second mixture from said second region to said second chamber is an outlet conduit to said second chamber.

The first chamber preferably comprises a single elongate tube having at one end said first inlet, and at an opposite end an outlet for the passage of second mixture to said second chamber, and between said first inlet and said outlet said second inlet disposed towards said one end for the input of buoyant media and said third inlet disposed between said second inlet and said outlet, so that influent material passes from said first inlet to said second outlet mixing first with the said buoyant media to form a first mixture and then with said flocculant to form said second mixture and thence to said second chamber.

Advantageously, through not exclusively, where potable water is to be treated there is provided a fourth inlet in the first chamber, disposed between the second and third inlets, for the introduction of coagulant.

The invention will now be described by way of example only and with reference to the accompanying drawings, in which:

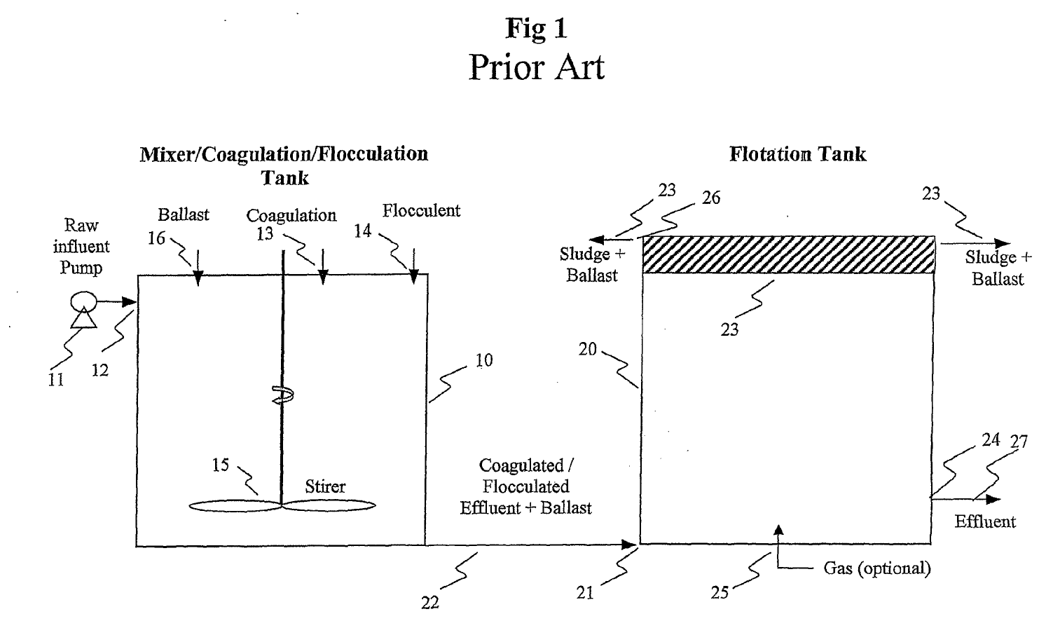

FIG. 1 is a schematic drawing of a prior art arrangement (which forms no part of the invention) by way of contrast to the present invention,

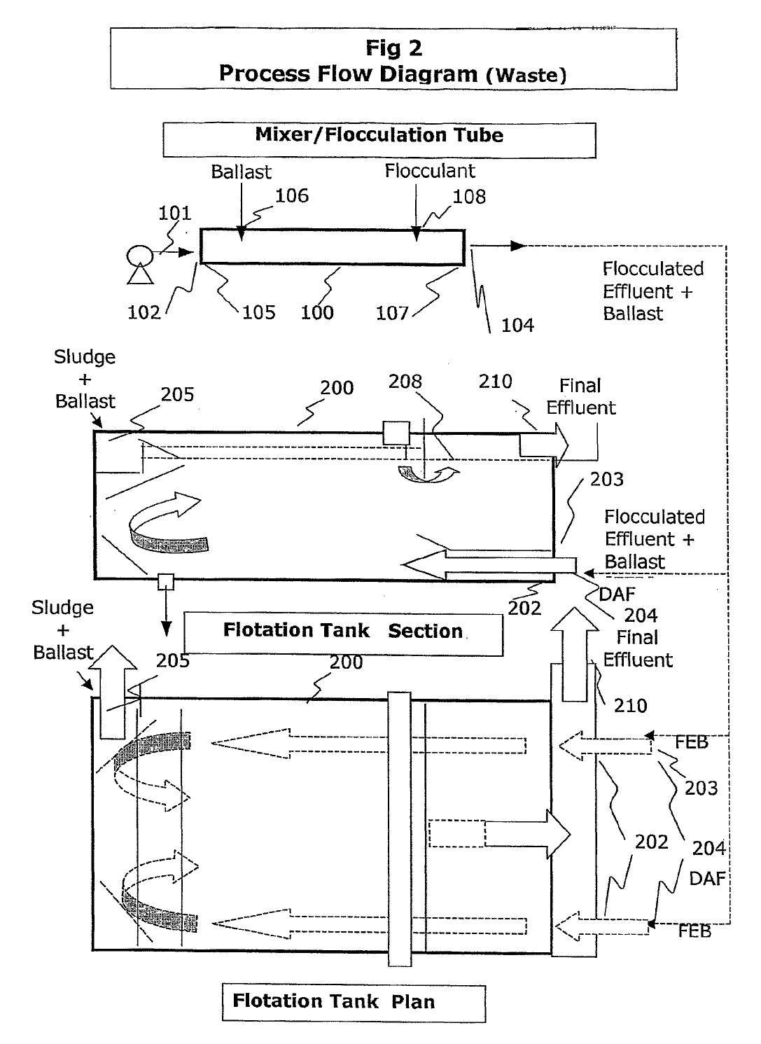

FIG. 2 is a schematic drawing of apparatus for use in the process of the invention, according to a first embodiment, and

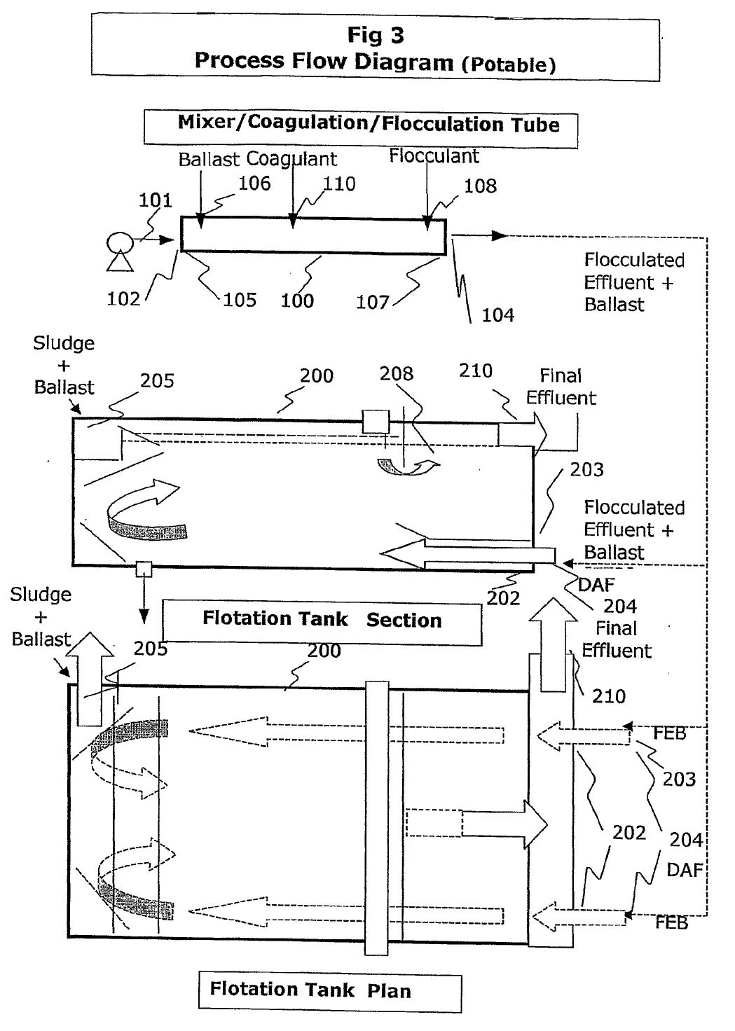

FIG. 3 is a schematic drawing of apparatus for use in the process of the invention according to a second embodiment.

In the prior art arrangement shown in FIG. 1, there are provided two tanks, a mixing/coagulation/flocculation (MCF) tank 10 and a flotation tank 20. Raw influent (waste water) is pumped into the MCF tank 10 by pump 11 via an inlet 12 where it is initially mixed with coagulant and/or flocculent which are introduced via inlets 13 and 14 respectively, and mixed with the raw influent by a stirrer 15 to form a first mixture. Ballast (buoyant media) is added via an inlet 16 which is mixed in with the first mixture by means of stirrer 15. The resulting product 22 is transferred to the flotation tank 20 via inlet 21 where the coagulated/flocculated sludge 23 (including ballast) floats to the top of the floatation tank and is removed mechanically through outlets 26. The clarified water 27 is removed via outlet 24. Optionally, a gas (typically air) is introduced via an inlet 25 to assist in the flotation of the sludge.

It has been found that this prior art system is not very efficient in that a high intensity stirrer is required for the coagulant and a less intense stirrer for the flocculent, the throughput is low especially where no DAF introduction is used. The separation of buoyant media (ballast) from sludge was found to be particularly inefficient.

A first embodiment of the invention, particularly though not exclusively suitable for the treatment of waste water having significant solid content is shown in FIG. 2. This comprises a first chamber 100 for mixing and flocculation and a second chamber 200 for floatation of separated solid waste (sludge). The first chamber 100 comprises an elongate tube into one end 105 of which is pumped raw influent (waste water) 101 through a first inlet 102, at an input end of the tube 105 and, at an opposite end 107, an outlet 104 for the transfer of treated waste water to the second chamber 200. There is also provided a second inlet 106 for buoyant media (ballast). The apparatus being designed (in known manner) to encourage turbulent flow mixing of the waste water influent with said ballast to form a first mixture of waste water and buoyant media (ballast). The latter mixture, passing generally towards the outlet end 107, is mixed with a flocculant (for example a polymer), again by arranging for turbulent flow mixing, before leaving via outlet 104 to pass into the flotation chamber 200. The flotation chamber is a tank having inlets 202 for said second mixture received from the first chamber. In this embodiment a portion 204 (about 7%) of the clarified effluent 208 is re-cycled, pressurised to about 5 bar, compressed air is dissolved in it at about 6 bar and then the re-cycled compressed effluent portion is entrained 203 with the said mixture before entering the flotation chamber 200.

The dissolved air is released on entry into the flotation chamber and assists in the flotation process providing dissolved air flotation (DAF). Sludge and ballast 205 is removed mechanically from the top of the flotation chamber 200. The final clarified effluent 210 is removed from the base of the flotation chamber 200. The apparatus and method of this first embodiment are capable of high throughput separation from a relatively compact apparatus.

A second embodiment of the invention is shown in FIG. 3. The method and apparatus of the third embodiment are more suitable for potable water solid separation and other applications where there is a relatively small size of suspended solids. The apparatus and method are similar to the first embodiment just described and the same reference numerals have been used to describe corresponding portions of the apparatus shown in FIG. 3 as that in FIG. 2.

The main difference is that between the second inlet 106 for buoyant media (ballast) and the third inlet 108 for flocculant, there is provided a further inlet 110 for a coagulant. The method involves mixing (by means of turbulence or otherwise)
a) the raw influent with the buoyant media to form a first mixture,
b) the mixture in a) above with coagulant to form another mixture, and
c) the mixture in b) above with flocculent to form a mixture of influent, buoyant media, coagulant and flocculant which is fed to the floatation chamber in a similar manner to that in the previous embodiment.

In the first embodiment of FIG. 2 the preferred media and flocculants are as follows.

Buoyant Media: Glass particles (spheres of diameter 30-250 micron, preferably 80-250 micron, most preferably about 120 micron, and bulk density of 50-500 kg per cubic metre preferably 200 kg per cubic metre. The buoyant media/influent ratio is 0.2-4 kg per cubic metre preferably about 2 kg per cubic metre.

Flocculant Cationic polyelectrolyte or Anionic polyelectrolyte. The flocculant/influent ratio is typically 0.0005-0.005 kg per cubic metre (0.5-5.0 mg/litre), but not for potable applications (see second embodiment detailed below).

In the second embodiment of FIG. 3 the preferred media and flocculants are as follows:

Buoyant Media: Glass spheres of diameter 30-250 micron, preferably 30-150 micron, most preferably about 80 micron, bulk density 50-500 kg per cubic metre, preferably 200 kg per cubic metre. The buoyant media/influent ratio is typically 0.1-2 kg per cubic metre preferably about 1 kg per cubic metre.

Flocculant Cationic polyelectrolyte or Anionic polyelectrolyte.

The flocculant/influent ratio is typically 0.000025-0.00025 kg per cubic metre (0.025-0.25 mg/litre). Typically 0.0002 kg per cubic metre. Flocculants should be minimised in potable applications.

Coagulant Ferric Chloride or Ferric Sulphate or Aluminium Sulphate or Aluminium Hydroxychlorosulphate in known amounts typically 10-60 mg/litre preferably about 45 mg/litre.

The sludge and media may be separated using a hydro-cyclone or vibrating sieve or otherwise in known manner to retrieve the media for re-use.

The following table is indicative of test work carried out on a variety of waters in the UK. This shows for a similar or slightly improved performance the dramatic increase in “flux rate” or throughput, by the use of the present invention, in comparison to the conventional processes in use today.

| | | | Result likely | Result likely | |
|---|---|---|---|---|---|
| | | | to be obtained | to be obtained | |
| | | | with the | with the | |
| | Characteristic | Conventional | conventional | present | |
| Process | feature | process | process | invention | Units |
| Potable | Flux Rate | Using DAF | 10-20 | 80 | m³/m²/hr |
| Water | | | | | |
| Clarification | | | | | |
| Waste Water | Flux Rate | Settlement | 1 | 120 | m³/m²/hr |
| Clarification | | | | | |
| Waste Water | Flux Rate | Using DAF | 10-30 | 120 | m³/m²/hr |
| Clarification | | | | | |
| Waste Water | Removal rate | Using | 90 | 95 | % of |
| | | settlement | | | initial |
| | | | | | NTU |
| Potable | Removal rate | Using | 80 | 80 | % of |
| Water | | settlement | | | initial |
| | | | | | NTU |

Normal clarification of Potable Water can be done by using DAF with addition of Co-agulant and flocculent, the flux rate would be up to 20 m³/m²/hr. The present invention, using the addition of light glass beads improves the flux rate or throughput to 80 m³/m²/hr.

Normal clarification of Waste Water by settlement would have a flux rate of circa 1 m³/m²/hr. Occasionally conventional DAF is used with addition of a flocculent; the flux rate could be up to 30 m³/m²/hr. The present invention, using the addition of light glass beads improves the flux rate or through put to 120 m³/m²/hr.

The recycling of the light media is an essential economic and sensitive environmental part of the process. Sludges containing the expensive and non bio-degradable beads would add to the disposal cost if left in the sludges. To recycle the beads it is essential that the classification is controlled between the ranges 70-150 microns, with the optimum size circa 120 micron. If the particle size is too small the method of removal is inefficient and leaves a large part remaining in the sludges. Too large and the beads have a poorer rise rate and a less efficient adherence of sludges to the surface.

Tests have shown that the removal of suspended solids from Waste Water centrate with an initial concentration of 3300 mg/l to be 95%.

Tests have shown that the removal of suspended solids from weak Waste Water with an initial concentration of 350 mg/l to be 93%.

Tests have shown that the removal of suspended solids from Potable Water with an initial turbidity of 45 NTU was reduced to 8 NTU compared with a conventional DAF process of 45 NTU to 10 NTU.

1. A process for separating suspended solid material from a fluid, comprising the steps of:
a) adding buoyant media to the fluid to form a first mixture of fluid influent and buoyant media,
b) adding a flocculant to the said first mixture to form a second mixture of influent, buoyant media and flocculent,
c) transferring said second mixture to a flotation chamber,
d) introducing a pressurized fluid to the second mixture in said flotation chamber,
e) removing separated floating sludge from said flotation chamber, and
f) removing separated clarified effluent from said flotation chamber.

2. A process as claimed in claim 1, additionally comprising the step of: adding a coagulant is to said first mixture to form a buoyant coagulated mixture, after step a) and before the addition of flocculants in step b).

3. A process as claimed in claim 2 in which said pressurized fluid includes a pressurized liquid including dissolved air.

4. A process as claimed in claim 3, wherein said fluid comprises a portion of the clarified effluent which is pressurized and in which a gas is dissolved before both are introduced into said flotation chamber.

5. A process as claimed in claim 4, wherein said portion is pressurized to approximately 5 bar, and said gas includes air which is dissolved in said portion at approximately 6 bar.

6. A process as claimed in claim 5, wherein said buoyant media comprises glass particles of bulk density in the range of approximately 50-500 kg per cubic metre.

7. A process as claimed in claim 6, wherein said buoyant media comprises glass particles of diameter in the range of approximately 30-250 micron and having a bulk density in the range of approximately 50-500 kg per cubic metre.

8. A process as claimed in claim 7, wherein said buoyant media comprises glass particles of diameters of approximately 30-150 microns.

9. A process as claimed in 7, wherein said buoyant media comprises glass particles of diameters of approximately 80-250 microns.

10. A process as claimed in claim 9, wherein said buoyant media comprises glass spherical particles of diameters of approximately 120 microns and a bulk density of approximately 200 kg per cubic meter.

11. An apparatus for the separation of suspended solid material from a fluid comprising:
a first chamber for the flocculation of the suspended material,
a second chamber for flotation of flocculated floating sludge from clarified influent to fluid,
means for transferring material from said first chamber to said second chamber, said first chamber including, a first inlet for influent, a second inlet for the introduction of buoyant media for entrainment and mixing of said buoyant media with said influent to form a first mixture, and,
a third inlet for flocculant material for entrainment and mixing of said flocculent with said already-mixed first mixture to form a second mixture, before said second mixture is transferred to said second chamber.

12. The apparatus as claimed in claim 11, wherein said first chamber is divided into two regions, a first region where said first and second inlets are disposed, and a second region in communication with said first region, and including said third inlet, and including said means for transferring said second mixture from said second region to said second chamber.

13. The apparatus as claimed in claim 11, wherein said first chamber comprises a single elongate chamber wherein said first inlet is at a first end, and an outlet is at a second end, opposite said first end for the passage of said second mixture to said second chamber, said second inlet is between said first inlet and said outlet, and disposed towards said first end for the input of buoyant medial and said third inlet is disposed between said second inlet and said outlet, so that influent material passes from said first inlet to said second outlet, mixing first with the buoyant media to form a first mixture, and then with said flocculant to form said second mixture, and then moving to said second chamber.

14. The apparatus as claimed in claim 13, additionally comprising: a fourth inlet in said first chamber, disposed between said second and third inlets, for the introduction of coagulant.

15-16. (canceled)
